(19) United States
(12) Patent Application Publication
(10) Pub. No.: US 2015/0286780 A1
(43) Pub. Date: Oct. 8, 2015

(54) Imaging Protocol Optimization With Consensus Of The Community

(71) Applicant: Siemens Medical Solutions USA, Inc., Malvern, PA (US)

(72) Inventors: Haris Saybasili, Chicago, IL (US); Sven Zuehlsdorff, Westmont, IL (US)

(73) Assignee: Siemens Medical Solutions USA, Inc., Malvern, PA (US)

(21) Appl. No.: 14/247,321

(22) Filed: Apr. 8, 2014

(51) Int. Cl. G06F 19/00; G07C 13/00

(52) U.S. Cl. CPC G06F 19/321; G07C 13/00

(57) ABSTRACT

A method for optimizing imaging protocols usage based on community voting includes a computer storing standard imaging protocol data associated with an imaging device type in a protocol database. The computer receives a request to modify the standard imaging protocol data. Next, the computer presents information from the request on a website accessible by a plurality of community members. Vote values are received from the community members via the website, each respective vote value selected from a range of values with a minimum value indicating rejection of the modified imaging protocol data and a maximum value indicating acceptance of the modified imaging protocol data. The computer then determines whether a consensus decision exists among the vote values. If the consensus decision exists, the computer determines whether to accept or reject the request to modify the standard imaging protocol data based on the consensus decision.

### TECHNICAL FIELD

The present invention relates generally to methods, systems, and apparatuses for optimizing imaging protocols using the consensus of an imaging community. The disclosed methods, systems, and apparatuses may be applied to, for example, imaging modalities such as Magnetic Resonance Imaging (MRI).

### BACKGROUND

Magnetic Resonance Imaging (MRI) is a non-invasive medical imaging technique that utilizes magnetization to visualize soft tissue. The contrast of MRI is extraordinarily flexible; several physical tissue properties can be used as contrast parameters to extract anatomical, morphological and even functional information. Tissue properties may include but are not limited to relaxation parameters, diffusion perfusion, flow, etc. The achieved image contrast strongly depends on the used Magnetic Resonance (MR) protocols—a specific set of imaging parameters that describe data acquisition and image reconstruction. Such imaging protocols are the core element of a clinical MRI study. The optimal selection of an imaging protocol and associated imaging parameters strongly impacts the image quality and diagnostic performance of the MRI study and requires careful optimization to clinical scenarios, diseases, body parts and patient habitus. Unfortunately, even small deviations from optimized MRI protocols may render an MR image as non-diagnostic, resulting in repeated scans or even call backs of the patients.

Although vendors of MRI scanners provide a wealth of MRI protocols for different clinical and patient scenarios, the further optimization and development of MRI protocols is an ongoing and dynamic process that often happens on local level and strongly depends on level of experience and expertise of the MRI technologists/radiologists/cardiologists and last, but not least, local preferences. Even if clinical relevant protocols are being optimized on a local level, the clinical community typically does not benefit from those developments as locally optimized protocols are typically not available to the public. Even if they are, the implementation of those modifications remains limited, or even disappears if there is no clear consensus of the community.

MRI protocols provided by the vendors typically cover the majority of clinical and patient scenarios. Often, these MRI protocols represent the state of the art based on the protocol development of a rather small group of application specialists or consultants. As a result, these protocols are adopted by users to reflect changes in standard of care or local preferences. However, if those changes are not executed with appropriate care, protocol modifications may impact image quality and overall diagnostic output in a detrimental fashion. Although professional societies such as Society of Cardiac Magnetic Resonance (SCMR) define minimum requirements for MRI protocols to obtain sufficient diagnostic MRI image quality, often, practical implementation of those protocols varies widely from one site to another. Therefore, image quality and diagnostic performance may be very different from site to site, potentially burdening the patient with repeated scans or studies and the healthcare system with additional costs. Moreover, adaptation of MRI protocols to reflect the state of the art, new clinical applications or emerging methods is typically rather slow and often depends on the release of new protocols by the vendors of MR scanners.

Accordingly, it is desired to make clinically relevant MRI protocols available that represent that state of the art and result in pristine image quality; a dynamic, community oriented, collaborative approach to modify the protocols will increase the stability and consistency.

### SUMMARY

Embodiments of the present invention address and overcome one or more of the above shortcomings and drawbacks, by providing methods, systems, and apparatuses that allow an imaging community to jointly optimize and further develop clinical imaging protocols. Consensus of an imaging community is used as a metric to measure the quality of images generated using optimized protocols. This technology is particularly well-suited for, but by no means limited to, imaging modalities such as Magnetic Resonance Imaging (MRI).

According to some embodiments of the present invention, a method for optimizing imaging protocols usage based on community voting includes a computer storing standard imaging protocol data associated with an imaging device type in a protocol database. The computer receives a request to modify the standard imaging protocol data. The request comprises an original image generated on a device of the imaging device type using the standard imaging protocol data, a new image generated on the device of the imaging device type using modified imaging protocol data, and a textual explanation of one or more modifications of the standard imaging protocol data used to create the modified imaging protocol data. Next, the computer presents the original image, the new image, and the textual explanation of one or more modifications on a website accessible by a plurality of community members. A plurality of vote values may be received from the plurality of community members via the website, each respective vote value selected from a range of values with a minimum value indicating rejection of the modified imaging protocol data and a maximum value indicating acceptance of the modified imaging protocol data. Then the computer determines whether a consensus decision exists among the plurality of vote values. If the consensus decision exists, the computer determines whether to accept or reject the request to modify the standard imaging protocol data based on the consensus decision. In some embodiments, if the consensus decision does not exist, the request to modify the standard imaging protocol data may be rejected.

In some embodiments of the aforementioned method, the computer also determines a distribution of the plurality of vote values between the minimum value and the maximum value. Then, the consensus decision may be determined based on the distribution. The distribution may also be used to determine whether the consensus decision exists among the plurality of vote values. For example, two portions of the distribution may be identified: a rejection portion comprising the minimum value and an endorsement portion comprising the maximum value. Then, a consensus decision may exist, for example, if the distribution includes a single peak in the rejection portion of the distribution or the endorsement portion of the distribution. In some embodiments, the method further includes the identification of a middle portion of the distribution between the rejection portion and the endorsement portion. Then, it may be determined that a consensus does not exist if, for example, the distribution does not include a single peak value, the distribution has a neutral peak value located in the middle portion, or the distribution is uniform.

The form of the website utilized in the aforementioned method may vary. For example, in one embodiment a graphical input element is presented on the website to allow selection of an input value between the minimum value and the maximum value. Then, the vote values may be received via the graphical input element. In one embodiment, a plurality of download links is presented on a second website accessible to the plurality of community members. These download links are operable to facilitate downloading of the standard imaging protocol data in a distinct imaging device format.

In some embodiments, the votes are weighted. For example, in one embodiment, a weighting process is performed for each respective vote value in the plurality of vote values. This process includes determining a weight value associated with a community member submitting the respective vote value and applying the weight value to the respective vote value prior to determining the consensus decision. These weighting values may be updated based on the results of the consensus decision. For example, if a respective vote value agrees with the consensus decision, the weight value associated with the community member submitting the respective vote value may be increased. Conversely, if the respective vote value disagrees with the consensus decision, the weight value associated with the community member submitting the respective vote value may be decreased. Various restrictions may be placed on the increase or decrease in weight value. For example, in one embodiment, the weight value associated with the community member submitting the respective vote value is restricted to a range of weight values between a predetermined minimum threshold and a predetermined maximum threshold. In one embodiment, the weight increase and/or decrease is inversely proportional to the existing weight value. Inactivity of a community member may also be used as a factor in decreasing weight value. For example, in one embodiment, a weight decrease rate due to inactivity of a community member is determined based on the time that the community member was inactive. This weight decrease rate may then be applied to the weighting value associated with the community member. In one embodiment, the weight decrease rate due to inactivity is linear if the inactivity time is greater than a predetermined threshold value.

According to other embodiments of the present invention, one or more of the features of aforementioned method may be used in various apparatuses and systems. For example, in one embodiment, an article of manufacture for optimizing imaging protocols usage based on community voting comprises a non-transitory, tangible computer-readable medium holding computer-executable instructions for performing the aforementioned method. According to other embodiments of the present invention, a system for optimizing imaging protocols usage based on community voting includes a database and a server computer. The database is configured to store standard imaging protocol data associated with an imaging device type in a protocol database. The server computer includes at least one processor and is configured to perform one or more of the features discussed above with respect to the aforementioned method.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shown a system for imaging protocol optimization based on community consensus, according to some embodiments of the present invention;

FIG. 2 is a flow chart describing the evaluation of a MR imaging protocol modification by the community, according to some embodiments of the present invention;

FIG. 3 is a flow chart describing the process of submitting a request to modify an existing protocol, according to some embodiments of the present invention;

FIG. 4 illustrates an example illustration of an input system which allows selection of an endorsement rating, according to some embodiments of the present invention;

FIG. 5 shows a weight level modification graph, representative of the weighting techniques used in some embodiments of the present invention;

FIG. 6 shows a graph which illustrates how weight level decreases due to inactivity of a community member, according to some embodiments of the present invention;

FIG. 7 shows an example distribution of the votes with large distributions in both the rejection and endorsement portions of the distribution;

FIG. 8 shows an example distribution of votes where a majority of the users are neutral to the modification;

FIG. 9 illustrates an example distribution of votes the community cannot reach to a conclusion without additional feedback;

FIG. 10 illustrates an example distribution of votes where there is a large community consensus for rejection of the modifications;

FIG. 11 shows an example distribution of votes where modifications are rejected by the community, with support from neutral users; and

FIG. 12 illustrates an exemplary computing environment within which embodiments of the invention may be implemented.

### DETAILED DESCRIPTION

The present invention relates generally to methods, systems, and apparatuses for optimizing imaging protocols using the consensus of an imaging community The various embodiments described herein offer several benefits to the imaging community. Imaging protocols may be stored in a centralized repository and made available online, thus allowing community members to view, add, delete, and modify imaging protocols available to the community. Additionally, community members may approve or reject modifications based on a consensus rating system. A centralized repository of imaging protocols will help to improve reproducibility and consistency of images across sites and department. In turn, this may help in reducing certain costs associated with performing imaging. The disclosed methods, systems, and apparatuses may be applied to, for example, imaging modalities such as Magnetic Resonance Imaging (MRI).

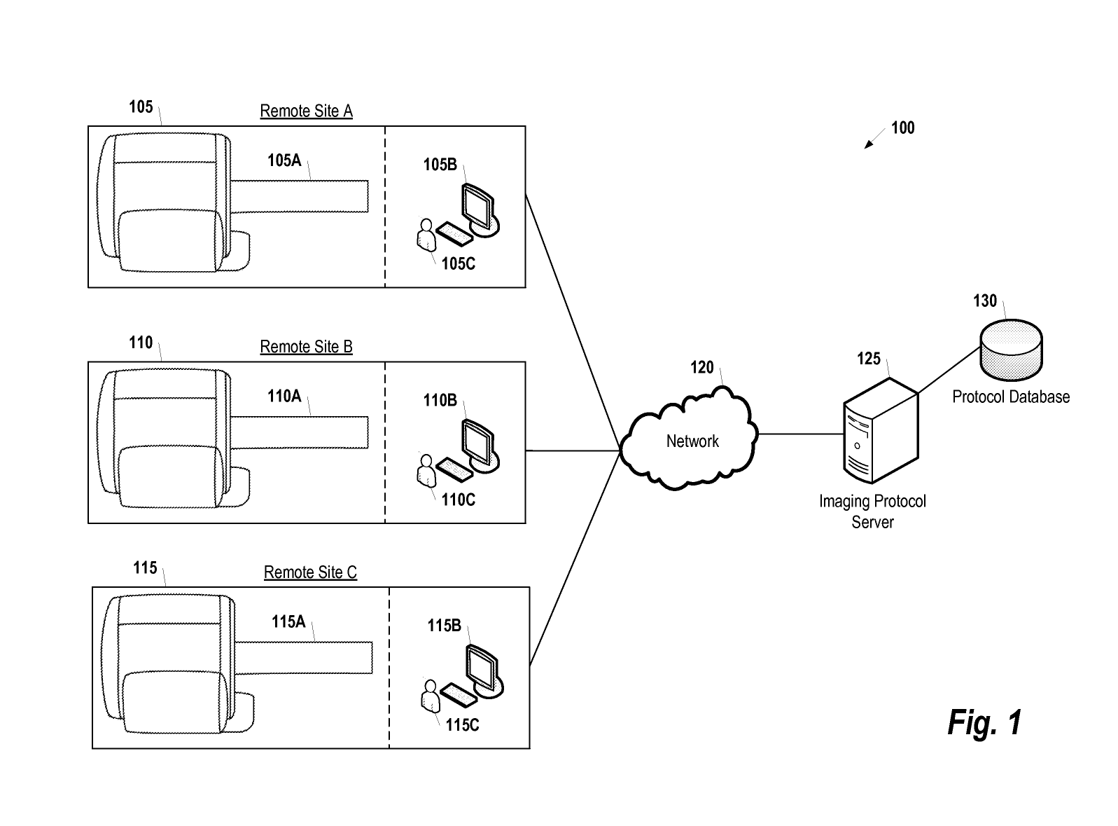

FIG. 1 shown a system 100 for imaging protocol optimization based on community consensus, according to some embodiments of the present invention. The system 100 allows the imaging community to jointly optimize and further develop clinical imaging protocols. The system includes three community members 105C, 110C, and 115C located at remote sites 105, 110, and 115, respectively. Imaging devices 105A, 110A, and 115A are also located at remote sites 105, 110, and 115, respectively, and allow the community members 105C, 110C, and 115C to implement imaging protocols. In the example of FIG. 1, imaging devices 105A, 110A, and 115A are each depicted as MRI device. In this instance, the imaging protocol may include information such as, without limitation, repetition time (TR), echo time (TE), spatial and temporal resolution, inversion times (TI). It should also be understood that the use of MRI devices in FIG. 1 is only one example of the types of imaging modalities which may be integrated with the methods, systems, and apparatuses described herein. In other embodiments, different imaging devices may be used with different corresponding protocols.

Using computers 105B, 110B, and 115B, the community members 105C, 110C, and 115C communicate over a network 120 with an Imaging Protocol Server 125. The Imaging Protocol Server 125 includes a Protocol Database 130 storing one or more imaging protocols. The imaging protocols stored in the Protocol Database 130 may include standard imaging protocols (e.g., Society for Cardiovascular Magnetic Resonance protocols) as well as modifications to the standard imaging protocols generated by one or more of the community members (e.g., community members 105C, 110C, and/or 115C). The Protocol Database 130 also stores a representative image for each imaging protocol, depicting results previously generated using a respective imaging protocol. In one embodiment, these representative images are stored using the Digital Imaging and Communications in Medicine (DICOM) format.

Through interaction with the Imaging Protocol Server 125, the community members 105C, 110C, and 115C are able to view, download, use, and submit modifications to the imaging protocols stored in the Protocol Database 130. For example, a community member may propose a new protocol or set of protocols, a modification to an existing protocol or set of protocols, or removal of an individual imaging protocol from a clinical study. In one embodiment, Imaging Protocol Server 125 is configured to present a wiki-type webpage to provide online tools for viewing and editing the imaging protocols. Any change to a standard protocol may be suggested via interaction with the Imaging Protocol Server 125. In some embodiments, the community member submitting the proposed modification is also required to provide a description of the modifications applied to the original protocol.

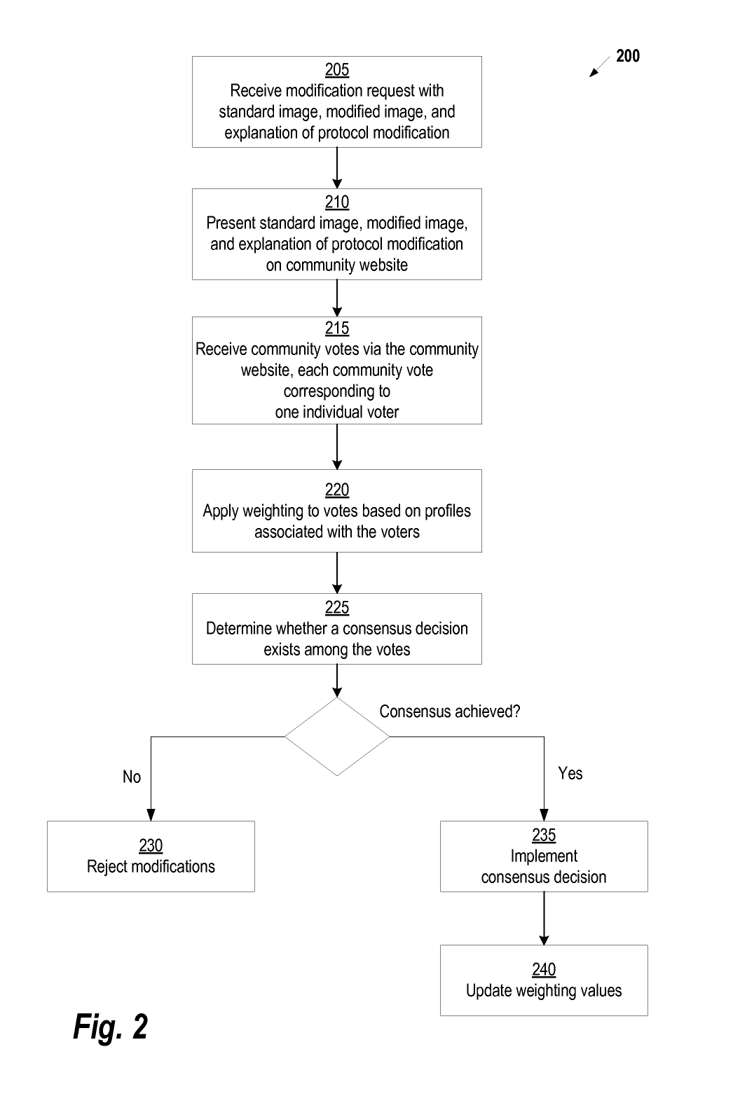

Once a modification to an imaging protocol is submitted and received by the Imaging Protocol Server 125, the modification is made available to users of the system (e.g. community members 105C, 110C, and 115C), for example via a webpage hosted by the Imaging Protocol Server 125. In some embodiments, the Imaging Protocol Server 125 stores and maintains all standard protocols, along with any proposed modifications, in a version control system. In such a system, each modified protocol may be presented as a “version” of an original, standard protocol. In one embodiment, the version control system further includes branching functionality, such that different modifications to the original protocol may be made in parallel. For example, one branch of modifications may focus on changes to one set of parameters included in the original protocol, while another branch focuses on changes to a different set of parameters included in the original protocol. These two branches can eventually be “merged” to create a new protocol that combines the changes made on both branches. Using the version control system, users may compare the original protocol with the suggested modifications, and see the differences. Users may also download the modified protocol and test it locally using their respective imaging systems. Each user can “vote” on a proposed modification, according to a process that is described in more detail below with respect to FIG. 2. In some embodiments, if a proposed modification is rejected by users, that modification will be removed from the system 100. However, if the modification is endorsed by the users, the changes in the modification will be merged with the standard protocol stored by the system 100.

FIG. 2 is a flow chart 200 describing the evaluation of a MR imaging protocol modification by the community, according to some embodiments of the present invention. At 205, a request to modify an imaging protocol is received by the Imaging Protocol Server 125. In the example of FIG. 2, the request includes three items. First, the request includes a first image generated (referred to herein as a “standard image”) on an imaging device (e.g., 105A) with an existing protocol. Second, the request includes an explanation of a proposed modification to the existing protocol. In some embodiments, this explanation is detailed enough such that the Imaging Protocol Server 125 can generate a new “modified” protocol based on the existing protocol. In other embodiments, the request may include a file with the modified protocol itself, thus allowing the explanation to be more general in its description of the proposed modifications. Third, the request includes a second image (referred to herein as a “modified image”) generated on the same imaging device as used to generate the first image, but using the modified protocol. In other embodiments, the request may not include all three of items illustrated in FIG. 2 or may include additional items. Next, at 210 information from the request is presented on a community website hosted by the Imaging Protocol Server 125. The information from the request may be presented using any technique or format known in the art. For example, with reference to information shown in FIG. 2, a webpage may be presented on a website for the imaging community. This webpage may show the standard image and the modified image side-by-side with the explanation of the modification to the protocol used to generate the modified image.

Next, at 215, the Imaging Protocol Server 125 community members (i.e., users of the system) vote for the proposed modification via the webpage on the imaging community site. In some embodiments, community members are sent requests, for example by email, inviting them to vote for the proposed modification to the imaging protocol via the website. In one embodiment, the webpage includes a graphical input which allows community members to select one of a range of values between endorsement and acceptance of the modification as a vote. The website may also allow user to submit additional comments with their votes, for example suggesting additional modifications to the protocol that may then be posted on the website.

Continuing with reference to FIG. 2, at 220, weighting is applied to votes based on profiles associated with the community members submitting. Each profile generally includes information regarding votes previously submitted by the respective community member and may also include additional information unique to the community member such as expertise with a particular imaging modality. This information may then be used to derive a weighting value for the community member which, in some embodiments, may then be stored in the profile and used when rating votes are submitted by an associated community member. For example, at 220, weighting values may be applied to ratings submitted by a community member to reflect his or her past activity using the system 100 and/or expertise. In some embodiments, the weighting values have one or more of the following properties. The maximum achievable weight may be capped to eliminate accumulation of unreasonably high weight. Additionally, the minimum achievable weight may also be capped. If a community member is already associated with a high weight value (e.g., above a predetermined threshold set by a system administrator) any increase to that weight may be “slowed down” by making weight increases inversely proportional to the size of the weight. Similarly, a decrease in weight may be higher for community members associated with high weight values. Also, a community member's weighting value may be decreased if that community member is inactive on the system 100 for an extended period of time.

Next, at 225, the Imaging Protocol Server 125 determines whether a consensus decision exists among the votes submitted by the community members. A consensus measurement may be determining using all the submitted votes or a subset of the submitted votes. The approach described herein may not impose any thresholds to initiate a consensus measurement since the decision is not solely made by the majority of the votes. Making decisions based on the majority of the votes may polarize the community rather than reaching the consensus. The use of consensus, as described herein, may be contrasted with open source approaches like Linux, or GNU is Not UNIX (GNU) that often do not implement strict measures for quality of modifications, or implement approval processes using steering committees. Steering committees impose theirs decisions on users' communities, rather than seeking consensus of a user's community. Therefore, the open source approach is not well suited for medical imaging community that includes multiple groups with similar aims to reach, often with conflicting methods in optimization strategies that may even lead to polarization rather than consensus of a community. Additionally, those steering committees may disband due to internal conflicts, thereby inflicting damage to the community. On the other hand, using the consensus as a quality metric can help guarantee the coalescence of the entire medical imaging community over a protocol modification. In some embodiments, any addition of a new imaging protocol or removal of an existing imaging protocol (or set of protocol) must undergo a consensus evaluation process as well.

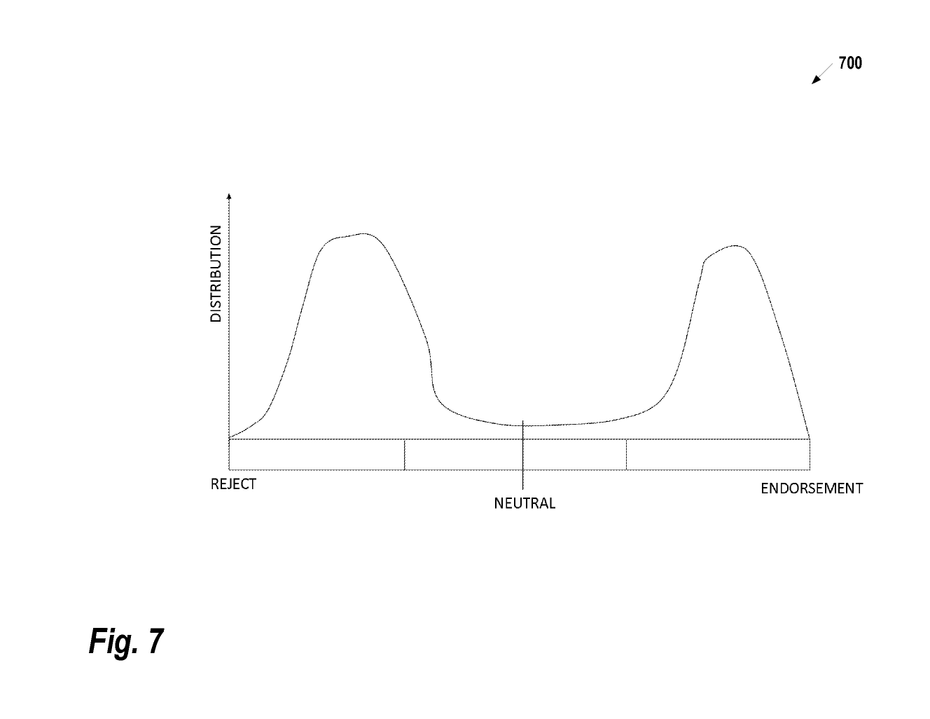

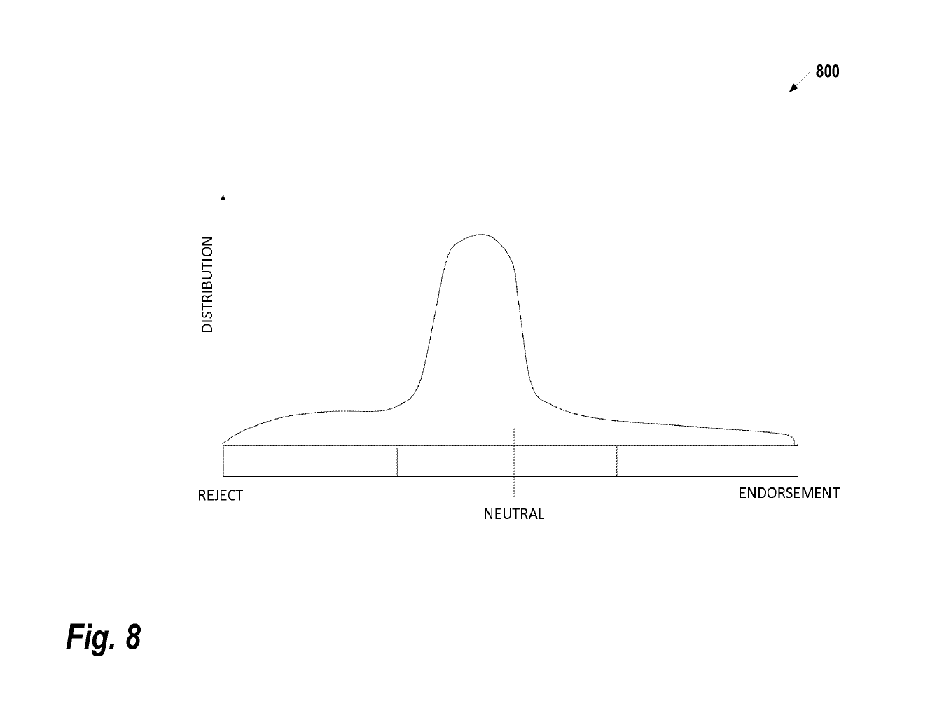

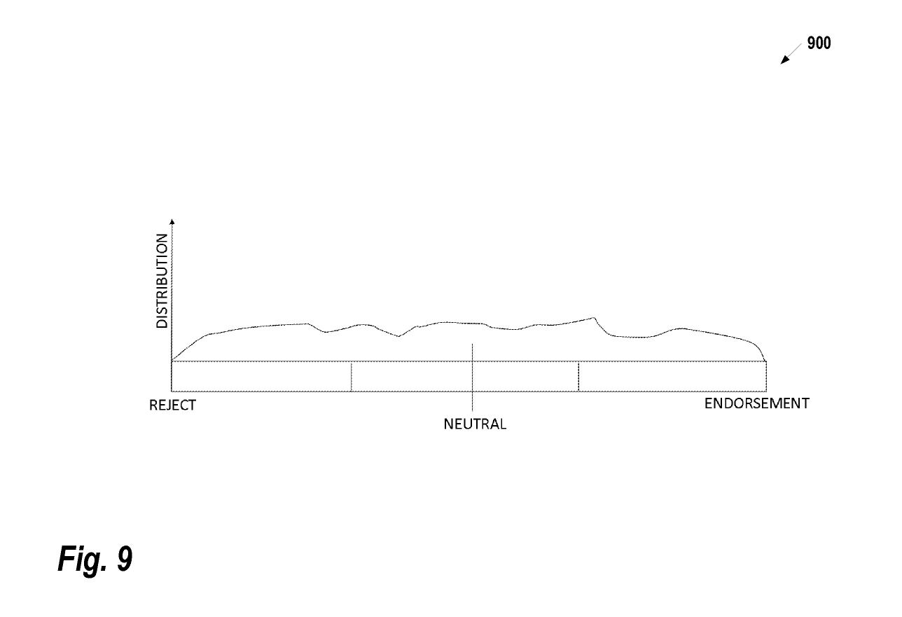

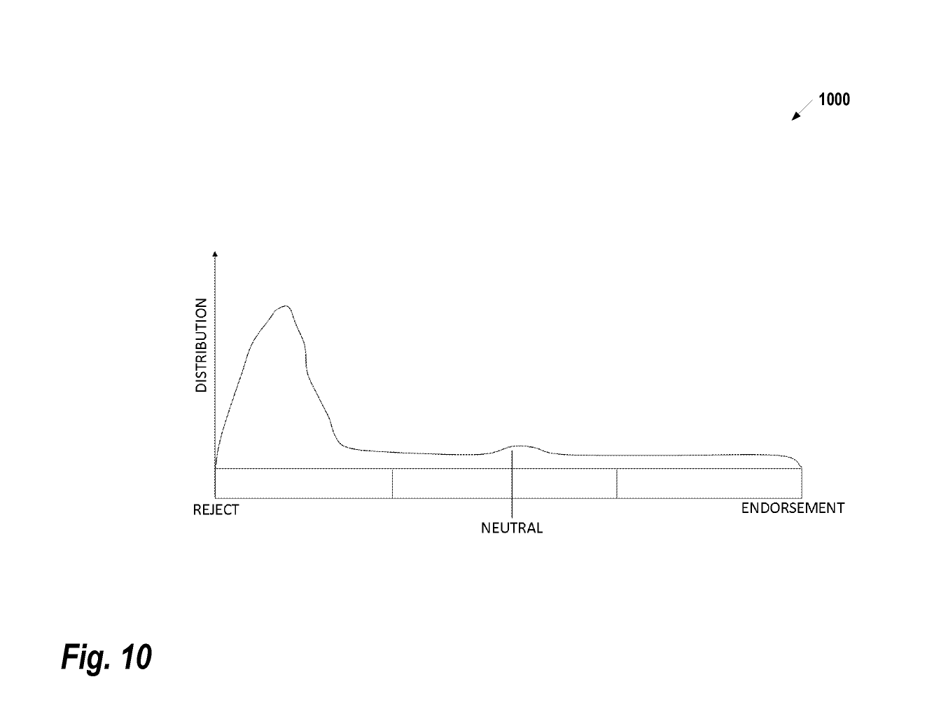

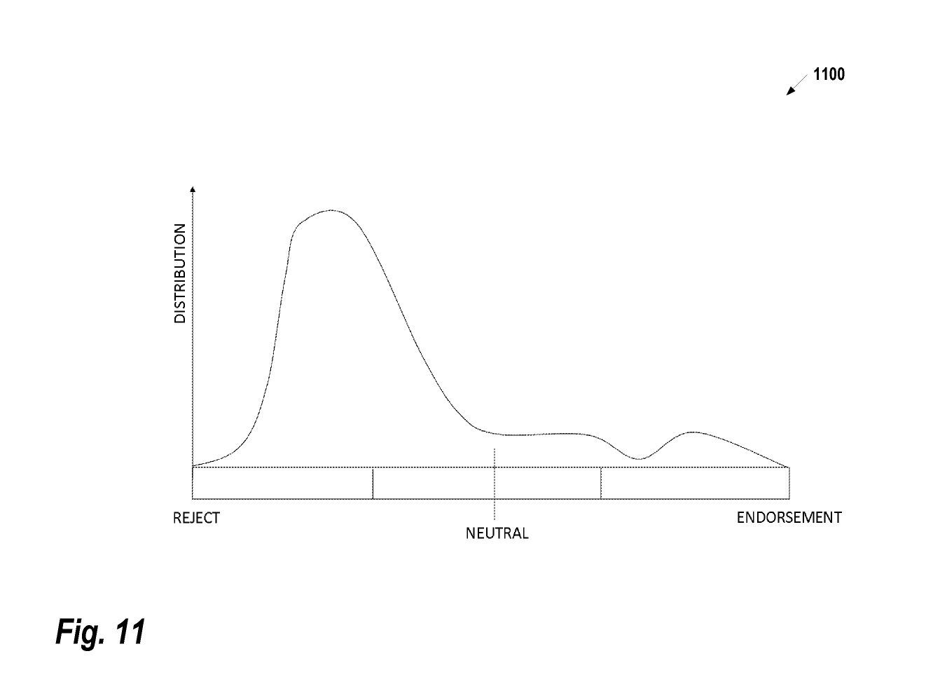

In some embodiments, to determine whether consensus exists at 225, a distribution of the votes submitted by the community members is calculated. This process, along with some illustrative examples, is described in greater detail below with reference to FIGS. 7-11. In these embodiments, the distribution of voting data over the entire rating spectrum (from “reject” to “endorse”) may be considered. Once voting ends, the distribution of the votes across a rating bar (e.g. a histogram of the votes) may be used as an indicator of the consensus. For example, in some embodiments, consensus is not reached and the modifications are not accepted, if the distribution is ambiguous (e.g. peaks at both ends of the spectrum as in FIG. 7), the distribution has a no preference indicating no impact (see, e.g., FIG. 8), the distribution is uniform across the spectrum (see, e.g., FIG. 9), or an equal distribution of ratings that does not indicate any preference. Conversely, consensus is reached, and thus the modifications are accepted, if the distribution is high only in one end of the spectrum showing clear consensus (see, e.g., FIG. 10) or the distribution is significantly higher in one side of the spectrum than the other (see, e.g., FIG. 11).

Returning to FIG. 2, if consensus is not achieved, the proposed modification is then rejected at 230. Conversely, if consensus was achieved, the consensus decision is implemented at 235. How the Imaging Protocol Server 125 implements the modification may vary, but may include adding a new protocol to the Protocol Database 130, removing a protocol from the Protocol Database 130, and/or modifying an existing protocol in the Protocol Database 130. In some embodiments, the Imaging Protocol Server 125 transmits a notification (e.g., email) to the community member that originally submitted the proposed modification, alerting him or her that the modification was rejected or implemented.

Continuing with reference to FIG. 2, at 240, weighting values are updated for the community members that submitted votes. In one embodiment, the weighting value associated with a community member may be decreased (penalized) or increased (rewarded) for future ratings based on whether consensus was achieved at 225. For example, the weighing value may be increased for future votes if the user successfully predicted the consensus of the community. Conversely, weighting values may be decreased for community members whose ratings turned out to be in disagreement with the consensus of the community, or in the case of inactivity. The approach grants more weight for community members that have been successful in predicting the consensus of the community for proposed modifications of an imaging protocol. The weighting may be viewed as a measure for expertise and to define agents or key opinion leaders of the community. Additionally, a potential weight increase could be seen as incentive to participate in the rating of proposed modifications of imaging protocols.

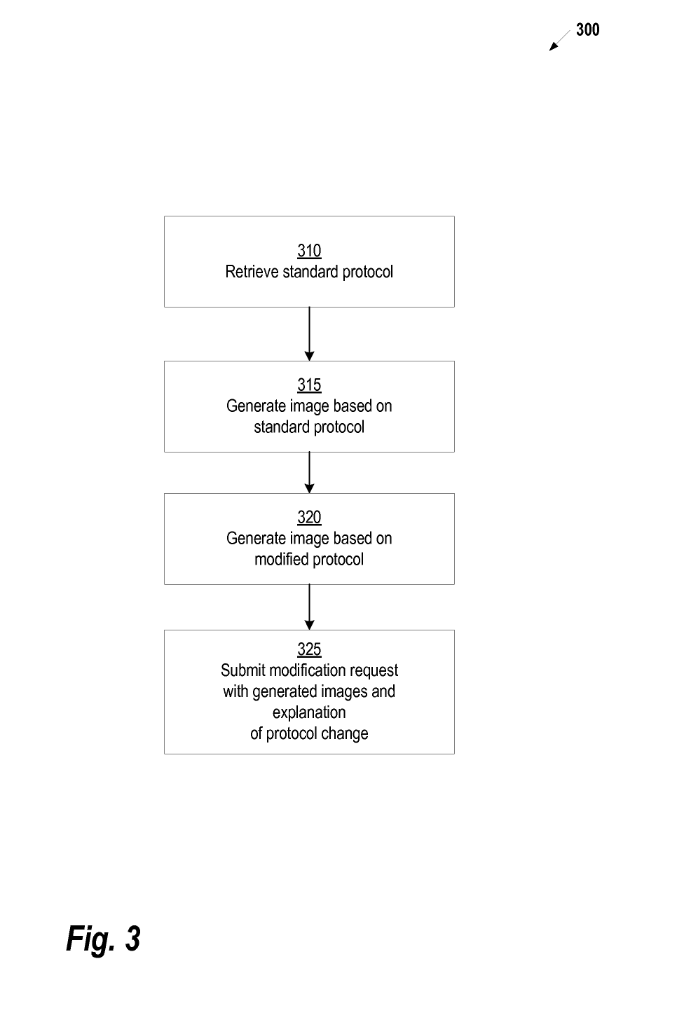

FIG. 3 is a flow chart 300 describing the process of submitting a request to modify an existing protocol, according to some embodiments of the present invention. At 310, a community member retrieves a standard protocol, for example via a download link at the website. In some embodiments, this link allows the user to download the protocol in a format suitable for a specific type of imaging device. In other embodiments, the format may be downloaded in a generic format that requires the community member to reformat it prior to use. Next, at 315, the user will run the current protocol via an imaging device (e.g., 105A), and save corresponding images, for example in DICOM format. Then, at 320, the community member runs his or her modified protocol during the same study, using the same imaging device, to generate one or more additional images which illustrate the effects of the proposed modification on the resulting image. Finally, at 325, the community member submits their modification request with the generated images and an explanation of the protocol change.

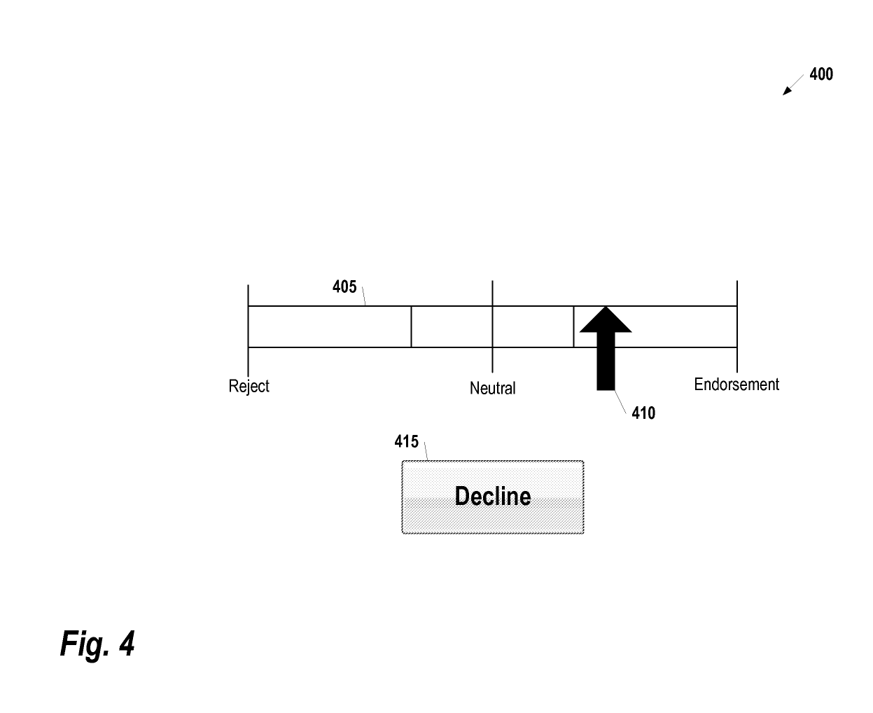

FIG. 4 illustrates an example illustration of an input system 400 which allows selection of an endorsement rating, according to some embodiments of the present invention. In some rating systems known in the art, users indicate a preference for one of two proposed options via a binary input (e.g., “like” or “not like”). However, such a rating system may not be appropriate for rating imaging protocols due to the number of changes that may occur due to a modification. For example, a modification to an imaging protocol may improve the image quality, while increasing scan time. Passing a judgment with a simple yes/no approach does not reflect well the nuances between straight out rejection, agreement or strong endorsement. Hence, in many cases, it would be inappropriate to measure consensus in this manner By contrast, in the example of FIG. 4, the input system 400 includes a slider 405 that allows community members to choose from the range of values between rejection and endorsement using the voting arrow 410. A central area (labeled “Neutral” in FIG. 4) may be used to indicate indifference to tendency to reject or endorse the modifications. The input system 400 includes separate decline button 415 for community members to indicate that they do not want to, or that do not feel competent enough to provide a rating. It should be noted that the input system 400 is merely illustrative and, in other embodiments, other input systems may be used such as, for example, drop-down menus, radio buttons, text input boxes, or voice input components.

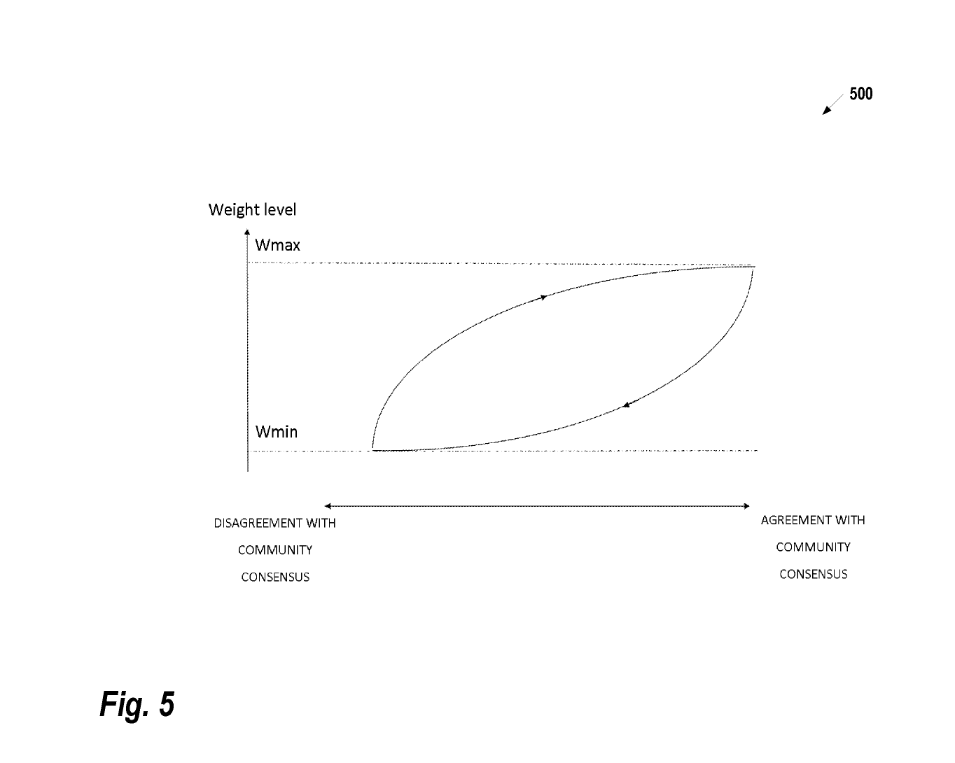

FIG. 5 shows a weight level modification graph 500, representative of the weighting techniques used in some embodiments of the present invention. Weighting values are initially set to a minimum value, Wmin. Over the course of time, weights will increase or decrease, in conjunction with the community member's agreement with community consensus. Both the decrease and increase in weights are non-linear, and dependent on the current weight level: weighting values decrease faster for high levels, and increase slower. In this example, weighting values cannot exceed maximum level, Wmax. An increased weighting value for a community member implies increased experience and/or expertise. Decreasing the rate of increase in weighting value by experience (or expertise) encourages the community members to contribute more, commensurately with their expertise. Additionally, capping the maximum weight will guarantee fairness in the rating procedure. If there were no caps, new or less experienced the ratings of community members associated with low weights would be negligible compared to community members associated with higher weighting values. As a result, ratings would be dominated by only high weighted users and no real consensus could be reached. Therefore, in some embodiments, the rate of increase will be inversely proportional to the level of the weight. If the weighting value is high, it will increase slowly. If the weight is low (e.g. 1), then the increase will be faster.

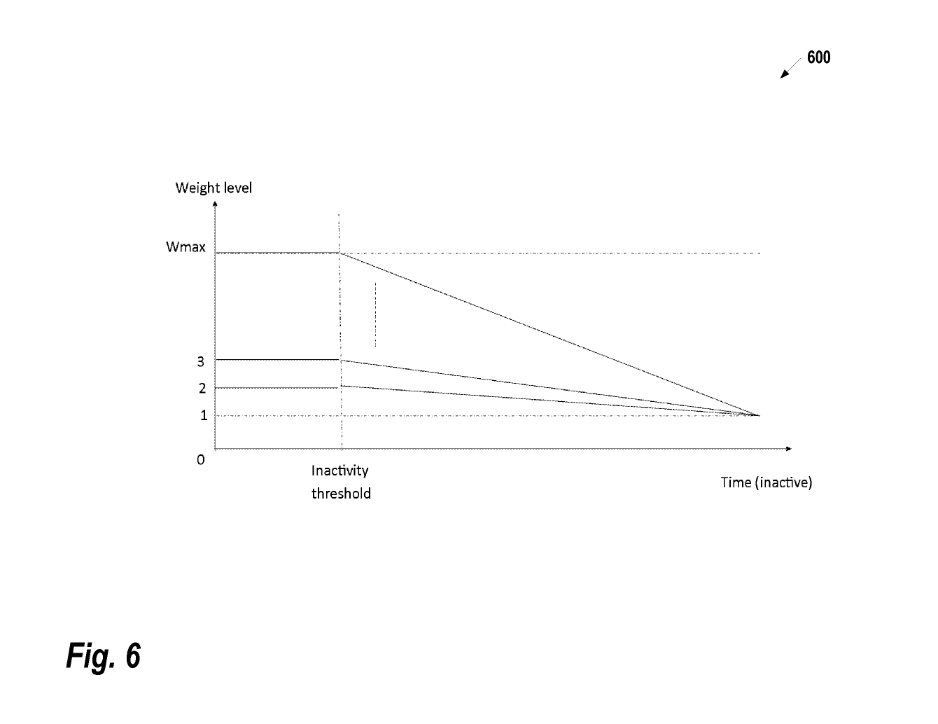

FIG. 6 shows a graph 600 which illustrates how weight level decreases due to inactivity of a community member, according to some embodiments of the present invention. Once the inactivity threshold is reached, the levels will decrease linearly. The rate of decline is proportional to the current weight level, with higher levels declining faster than lower levels. The inactivity may be measured, for example, as non-response to invites rate a modification of an imaging protocol. Intentionally declining to rate a change may not qualify as inactivity. The weighting value for an inactive user may be linearly reduced to an initial value after a grace period of missed ratings. Declining to submit a rating may or may not be considered as inactivity. For example, if a community choses to decline, his/her weighting value will not be modified after the consensus is reached.

FIGS. 7-11 illustrate various distributions of votes, as may be generated according to some embodiments of the present invention. FIG. 7 shows an example distribution of the votes 700 with large distributions in both the rejection and endorsement portions of the distribution. In this example, a majority of the users endorsed the modification. However, a large group did not endorse it. No consensus is reached due to polarization in the community and the modifications will be rejected. FIG. 8 shows an example distribution of votes 800 where a majority of the users are neutral to the modification. Note that, in this example, a slight majority endorsed the changes. However, the modifications will be dropped due to lack of impact. FIG. 9 illustrates an example distribution of votes 900 the community cannot reach to a conclusion without additional feedback. If a threshold amount of feedback is not received within a predetermined time period (e.g., set by a system administrator), the proposed modifications are dropped. FIG. 10 illustrates an example distribution of votes 1000 where there is a large community consensus for rejection of the modifications. Because the graph shows clear consensus, modifications will not be implemented. FIG. 11 shows an example distribution of votes 1100 where modifications are rejected by the community, with support from neutral users. In this case, the modifications will also not be implemented.

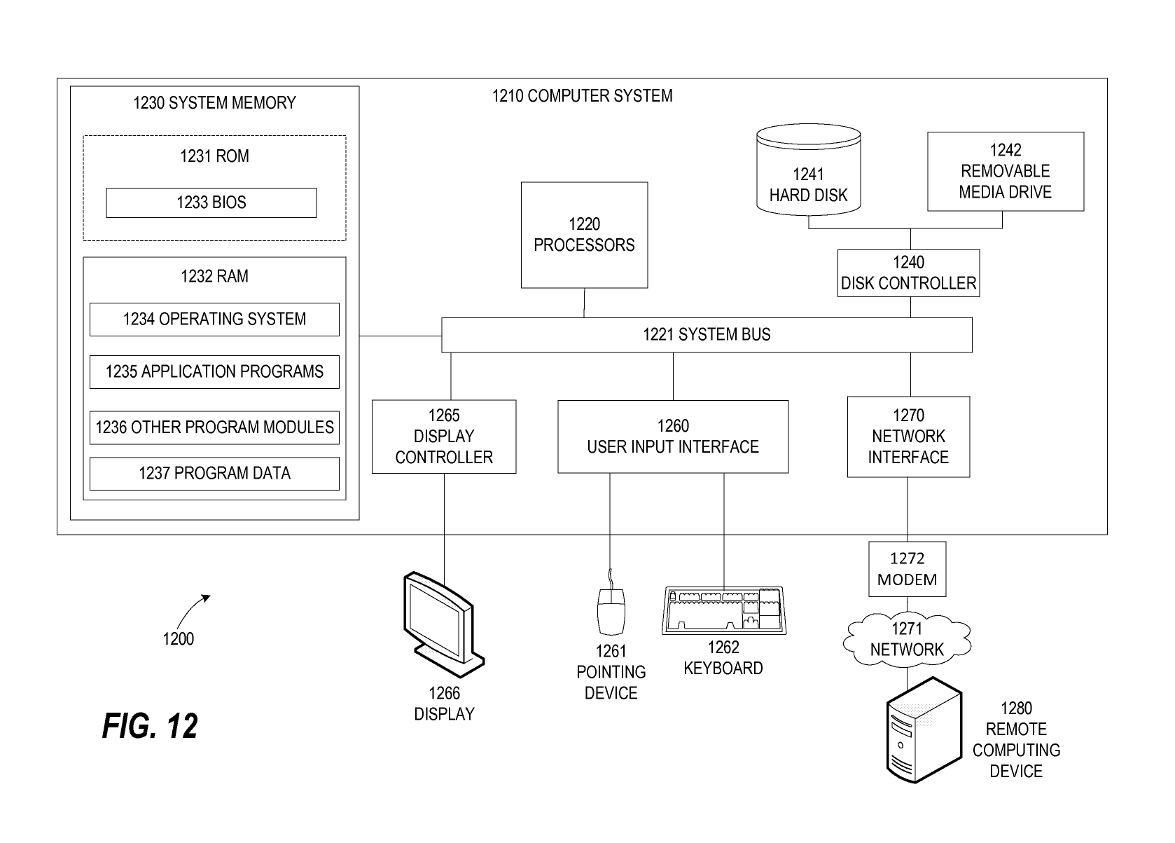

FIG. 12 illustrates an exemplary computing environment 1200 within which embodiments of the invention may be implemented. For example, computing environment 1200 may be used to implement one or more components of system 100 shown in FIG. 1. Computers and computing environments, such as computer system 1210 and computing environment 1200, are known to those of skill in the art and thus are described briefly here.

As shown in FIG. 12, the computer system 1210 may include a communication mechanism such as a system bus 1221 or other communication mechanism for communicating information within the computer system 1210. The computer system 1210 further includes one or more processors 1220 coupled with the system bus 1221 for processing the information.

The processors 1220 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 12, the computer system 1210 also includes a system memory 1230 coupled to the system bus 1221 for storing information and instructions to be executed by processors 1220. The system memory 1230 may include computer readable storage media in the form of volatile and/or nonvolatile memory, such as read only memory (ROM) 1231 and/or random access memory (RAM) 1232. The system memory RAM 1232 may include other dynamic storage device(s) (e.g., dynamic RAM, static RAM, and synchronous DRAM). The system memory ROM 1231 may include other static storage device(s) (e.g., programmable ROM, erasable PROM, and electrically erasable PROM). In addition, the system memory 1230 may be used for storing temporary variables or other intermediate information during the execution of instructions by the processors 1220. A basic input/output system 1233 (BIOS) containing the basic routines that help to transfer information between elements within computer system 1210, such as during start-up, may be stored in system memory ROM 1231. System memory RAM 1232 may contain data and/or program modules that are immediately accessible to and/or presently being operated on by the processors 1220. System memory 1230 may additionally include, for example, operating system 1234, application programs 1235, other program modules 1236 and program data 1237.

The computer system 1210 also includes a disk controller 1240 coupled to the system bus 1221 to control one or more storage devices for storing information and instructions, such as a magnetic hard disk 1241 and a removable media drive 1242 (e.g., floppy disk drive, compact disc drive, tape drive, and/or solid state drive). The storage devices may be added to the computer system 1210 using an appropriate device interface (e.g., a small computer system interface (SCSI), integrated device electronics (IDE), Universal Serial Bus (USB), or FireWire).

The computer system 1210 may also include a display controller 1265 coupled to the system bus 1221 to control a display 1266, such as a cathode ray tube (CRT) or liquid crystal display (LCD), for displaying information to a computer user. The computer system includes an input interface 1260 and one or more input devices, such as a keyboard 1262 and a pointing device 1261, for interacting with a computer user and providing information to the one or more processors 1220. The pointing device 1261, for example, may be a mouse, a light pen, a trackball, or a pointing stick for communicating direction information and command selections to the one or more processors 1220 and for controlling cursor movement on the display 1266. The display 1266 may provide a touch screen interface which allows input to supplement or replace the communication of direction information and command selections by the pointing device 1261.

The computer system 1210 may perform a portion or all of the processing steps of embodiments of the invention in response to the one or more processors 1220 executing one or more sequences of one or more instructions contained in a memory, such as the system memory 1230. Such instructions may be read into the system memory 1230 from another computer readable medium, such as a magnetic hard disk 1241 or a removable media drive 1242. The hard disk 1241 may contain one or more datastores and data files used by embodiments of the present invention. Datastore contents and data files may be encrypted to improve security. The processors 1220 may also be employed in a multi-processing arrangement to execute the one or more sequences of instructions contained in system memory 1230. In alternative embodiments, hard-wired circuitry may be used in place of or in combination with software instructions. Thus, embodiments are not limited to any specific combination of hardware circuitry and software.

As stated above, the computer system 1210 may include at least one computer readable medium or memory for holding instructions programmed according to embodiments of the invention and for containing data structures, tables, records, or other data described herein. The term “computer readable medium” as used herein refers to any medium that participates in providing instructions to the one or more processors 1220 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as hard disk 1241 or removable media drive 1242. Non-limiting examples of volatile media include dynamic memory, such as system memory 1230. Non-limiting examples of transmission media include coaxial cables, copper wire, and fiber optics, including the wires that make up the system bus 1221. Transmission media may also take the form of acoustic or light waves, such as those generated during radio wave and infrared data communications.

The computing environment 1200 may further include the computer system 1210 operating in a networked environment using logical connections to one or more remote computers, such as remote computer 1280. Remote computer 1280 may be a personal computer (laptop or desktop), a mobile device, a server, a router, a network PC, a peer device or other common network node, and typically includes many or all of the elements described above relative to computer system 1210. When used in a networking environment, computer system 1210 may include modem 1272 for establishing communications over a network 1271, such as the Internet. Modem 1272 may be connected to system bus 1221 via user network interface 1270, or via another appropriate mechanism.

Network 1271 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 1210 and other computers (e.g., remote computing 1280). The network 1271 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 1271.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically, wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

We claim:

1. A method for optimizing imaging protocols usage based on community voting, the method comprising:
storing, by a computer, standard imaging protocol data associated with an imaging device type in a protocol database;
receiving, by the computer, a request to modify the standard imaging protocol data, the request comprising:
an original image generated on a device of the imaging device type using the standard imaging protocol data,
a new image generated on the device of the imaging device type using modified imaging protocol data, and
a textual explanation of one or more modifications of the standard imaging protocol data used to create the modified imaging protocol data;
presenting, by the computer, the original image, the new image, and the textual explanation of one or more modifications on a website accessible by a plurality of community members;
receiving, by the computer, a plurality of vote values from the plurality of community members via the website, each respective vote value selected from a range of values with a minimum value indicating rejection of the modified imaging protocol data and a maximum value indicating acceptance of the modified imaging protocol data;
determining, by the computer, whether a consensus decision exists among the plurality of vote values; and
if the consensus decision exists, determining, by the computer, whether to accept or reject the request to modify the standard imaging protocol data based on the consensus decision.

2. The method of claim 1, further comprising:
if the consensus decision does not exist, rejecting the request to modify the standard imaging protocol data based on the consensus decision.

3. The method of claim 1, further comprising:
determining a distribution of the plurality of vote values between the minimum value and the maximum value,
wherein the consensus decision is determined based on the distribution.

4. The method of claim 3, wherein determining whether the consensus decision exists among the plurality of vote values comprises:
identifying a rejection portion of the distribution comprising the minimum value;
identifying an endorsement portion of the distribution comprising the maximum value;
determining that the consensus decision exists if the distribution includes a single peak in the rejection portion of the distribution or the endorsement portion of the distribution.

5. The method of claim 3, wherein determining whether the consensus decision exists among the plurality of vote values comprises:
identifying a rejection portion of the distribution comprising the minimum value;
identifying an endorsement portion of the distribution comprising the maximum value;
identifying a middle portion of the distribution between the rejection portion and the endorsement portion; and
determining that the consensus decision does not exist if:
the distribution does not include a single peak value,
the distribution has a neutral peak value located in the middle portion, or
the distribution is uniform.

6. The method of claim 1, wherein the method further comprises:
presenting a graphical input element on the website, the graphical input element allowing selection of an input value between the minimum value and the maximum value,
wherein each of the plurality of vote values is received via the graphical input element.

7. The method of claim 1, further comprising:
presenting a plurality of download links on a second website accessible to the plurality of community members, each respective download link operable to facilitate downloading of the standard imaging protocol data in a distinct imaging device format.

8. The method of claim 1, further comprising:
for each respective vote value in the plurality of vote values, performing a weighting process comprising:
determining a weight value associated with a community member submitting the respective vote value, and
applying the weight value to the respective vote value prior to determining the consensus decision.

9. The method of claim 8, further comprising:
for each respective vote value in the plurality of vote values, performing an update process comprising:
if the respective vote value agrees with the consensus decision, increasing the weight value associated with the community member submitting the respective vote value, and
if the respective vote value disagrees with the consensus decision, decreasing the weight value associated with the community member submitting the respective vote value.

10. The method of claim 9, wherein the weight value associated with the community member submitting the respective vote value is restricted to a range of weight values between a predetermined minimum threshold and a predetermined maximum threshold.

11. The method of claim 9, wherein increasing the weight value associated with the community member submitting the respective vote value comprises:
determining an existing weight value associated with the community member submitting the respective vote value;
calculating a weight increase value which is inversely proportional to the existing weight value; and
increasing the existing weight value by the weight increase value.

12. The method of claim 9, wherein decreasing the weight value associated with the community member submitting the respective vote value comprises:
determining an existing weight value associated with the community member submitting the respective vote value;
calculating a weight decrease value which is inversely proportional to the existing weight value; and
decreasing the existing weight value by the weight decrease value.

13. The method of claim 8, further comprising:
determining an inactivity time associated with an inactive community member;
determining a weight decrease rate due to inactivity based on the inactivity time, wherein the weight decrease rate due to inactivity is linear if the inactivity time is greater than a predetermined threshold value; and
applying the weight decrease rate due to inactivity to a weighting value associated with the inactive community member.

14. An article of manufacture for optimizing imaging protocols usage based on community voting, the article of manufacture comprising a non-transitory, tangible computer-readable medium holding computer-executable instructions for performing a method comprising:
storing standard imaging protocol data associated with an imaging device type in a protocol database;
receiving a request to modify the standard imaging protocol data, the request comprising:
an original image generated on a device of the imaging device type using the standard imaging protocol data,
a new image generated on the device of the imaging device type using modified imaging protocol data, and
a textual explanation of one or more modifications of the standard imaging protocol data used to create the modified imaging protocol data;
presenting the original image, the new image, and the textual explanation of one or more modifications on a website accessible by a plurality of community members;
receiving a plurality of vote values from the plurality of community members via the website, each respective vote value selected from a range of values with a minimum value indicating rejection of the modified imaging protocol data and a maximum value indicating acceptance of the modified imaging protocol data;
determining whether a consensus decision exists among the plurality of vote values; and
if the consensus decision exists, determining whether to accept or reject the request to modify the standard imaging protocol data based on the consensus decision.

15. The article of manufacture of claim 14, wherein the method further comprises:
determining a distribution of the plurality of vote values between the minimum value and the maximum value,
wherein the consensus decision is determined based on the distribution.

16. The article of manufacture of claim 15, wherein determining whether the consensus decision exists among the plurality of vote values comprises:
identifying a rejection portion of the distribution comprising the minimum value;
identifying an endorsement portion of the distribution comprising the maximum value;
determining that the consensus decision exists if the distribution includes a single peak in the rejection portion of the distribution or the endorsement portion of the distribution.

17. The article of manufacture of claim 15, wherein determining whether the consensus decision exists among the plurality of vote values comprises:
identifying a rejection portion of the distribution comprising the minimum value;
identifying an endorsement portion of the distribution comprising the maximum value;
identifying a middle portion of the distribution between the rejection portion and the endorsement portion; and
determining that the consensus decision does not exist if:
the distribution does not include a single peak value,
the distribution has a neutral peak value located in the middle portion, or
the distribution is uniform.

18. The article of manufacture of claim 14, wherein the method further comprises:
for each respective vote value in the plurality of vote values, performing a weighting process comprising:
determining a weight value associated with a community member submitting the respective vote value, and
applying the weight value to the respective vote value prior to determining the consensus decision.

19. The article of manufacture of claim 18, wherein the method further comprises:
for each respective vote value in the plurality of vote values, performing an update process comprising:
if the respective vote value agrees with the consensus decision, increasing the weight value associated with the community member submitting the respective vote value, and
if the respective vote value disagrees with the consensus decision, decreasing the weight value associated with the community member submitting the respective vote value.

20. A system for optimizing imaging protocols usage based on community voting, the system comprising:
a database configured to store standard imaging protocol data associated with an imaging device type in a protocol database;
a server computer comprising at least one processor and configured to:
receive a request to modify the standard imaging protocol data, the request comprising: an original image generated on a device of the imaging device type using the standard imaging protocol data, a new image generated on the device of the imaging device type using modified imaging protocol data, and a textual explanation of one or more modifications of the standard imaging protocol data used to create the modified imaging protocol data;
present the original image, the new image, and the textual explanation of one or more modifications on a website accessible by a plurality of community members;
receive a plurality of vote values from the plurality of community members via the website, each respective vote value selected from a range of values with a minimum value indicating rejection of the modified imaging protocol data and a maximum value indicating acceptance of the modified imaging protocol data;
determine whether a consensus decision exists among the plurality of vote values; and
if the consensus decision exists, determine whether to accept or reject the request to modify the standard imaging protocol data based on the consensus decision.
